(19) United States
(12) Patent Application Publication
(10) Pub. No.: US 2026/0225239 A1
(43) Pub. Date: Aug. 6, 2026

(54) SYSTEMS AND METHODS FOR CONTROLLING STIFFNESSES DURING A TASK BY A ROBOT

(71) Applicant: Toyota Research Institute, Inc., Los Altos, CA (US)

(72) Inventors: Yifan Hou, Sunnyvale, CA (US); Zeyi Liu, Stanford, CA (US); Cheng Chi, New York, NY (US); Eric A. Cousineau, Sommerville, MA (US); Naveen Kuppuswamy, Saugus, MA (US); Siyuan Feng, Cambridge, MA (US); Benjamin Burchfiel, Somerville, MA (US); Shuran Song, Stanford, CA (US)

(73) Assignees: Toyota Research Institute, Inc., Los Altos, CA (US); Toyota Jidosha Kabushiki Kaisha, Toyota-shi Aichi-ken (JP); The Board of Trustees of the Leland Stanford Junior University, Stanford, CA (US); Columbia University, New York, NY (US)

(21) Appl. No.: 19/042,495

(22) Filed: Jan. 31, 2025

(51) Int. Cl. B25J 9/16

(52) U.S. Cl. CPC B25J 9/1653; B25J 9/161; B25J 9/1661; B25J 9/1697

(57) ABSTRACT

Systems, methods, and other embodiments described herein relate to controlling a robot during a task while satisfying compliance parameters by estimating stiffnesses and a virtual target associated with a motion. In one embodiment, a method includes estimating stiffnesses and a virtual target using a policy model from an image, a proprioception, and a force about a task by a robot, the stiffnesses associated with a spatial point. The method also includes computing a stiffness matrix for compliance parameters by a compliance component from a pose, the stiffnesses, and the virtual target. The method also includes controlling the robot during the task using a compliance controller parameterized by the virtual target and the stiffness matrix.

### TECHNICAL FIELD

The subject matter described herein relates, in general, to computing stiffness for a robotic task, and, more particularly, to controlling a robot during a task by estimating stiffnesses and a virtual target while satisfying a policy.

### BACKGROUND

Robots are becoming more prevalent in various environments such as homes, healthcare, and manufacturing. For example, a robotic vacuum automatically maintains a home with minimal effort using environment mapping and perception. Robots also assist with surgery and reduce recovery times in healthcare through improving precision. Furthermore, systems are developing autonomous delivery robots for delivering food and packages directly to consumers. Additionally, factories and warehouses are utilizing robots for assembly, inventory management, thereby boosting productivity and reducing human labor.

Controlling robots in these and other environments can involve balancing between control of position and force with surrounding uncertainties. In particular, this includes the ability of a robot to adapt with external forces and environmental changes while maintaining controlled motion. Systems sometimes overlook control parameters within visuomotor guidelines. For example, a policy focuses upon motion direction without comprehensively accounting for pressure. A robot manipulating an object during a task can encounter optimization difficulties when lacking accurate control associated with motion, thereby reducing system performance and reliability.

### SUMMARY

In one embodiment, example systems and methods relate to controlling a robot during a task while satisfying compliance parameters by estimating stiffnesses and a virtual target associated with a motion. In various implementations, systems using a robot to manipulate an object and motion demand concurrent control of position and force for achieving target outcomes. In one approach, a joint objective is captured through mechanical compliance where diminished compliance prioritizes position accuracy regardless of external forces. Elevated compliance allows position deviation in response to external forces that can make the system “soft” during an interaction. A robot satisfying a target compliance involves dynamic properties that can vary depending on a task objective and a system state. For instance, a robotic controller executing a flipping task with an object factors temporal and spatial variation for contact points, pivot points, etc. The robotic controller and other systems encounter difficulties handling new scene configurations, unexpected perturbations, etc., when added to these variations, thereby reducing system reliability and robustness.

Therefore, in one embodiment, an estimation system has a policy model that dynamically adjusts compliance spatially and temporally for a task by a robot using multiple stiffness values that improve movement accuracy. The estimation system can approximate compliance parameters associated with a spatial point that avoids elevated contact forces during the task, thereby improving tracking accuracy and precision. For instance, the estimation system predicts the stiffness values and a virtual target for a motion using the policy model by inputting an image about the spatial point, proprioception data, and force data about the task. This allows the estimation system to maintain diverse contact modes despite uncertainties and disturbances during the task (e.g., a manipulation task). In one approach, the estimation system trains the policy model using a demonstrated task that avoids limited learning from using pre-selected compliance parameters and assuming uniform stiffness. For example, the estimation system trains the policy model using a diffusion policy through removing noise from the demonstrated task using a pose (e.g., a spatiotemporal position) about the robot, test stiffnesses, and a virtual target. Accordingly, the estimation system improves movement accuracy by training the policy model to estimate the multiple stiffness values for the task by the robot using the demonstrated task, thereby increasing reliability and confidence with the task and robotic control.

In one embodiment, an estimation system that controls a robot during a task while satisfying compliance parameters through estimating stiffnesses and a virtual target associated with a motion is disclosed. The estimation system includes a memory including instructions that, when executed by the processor, cause the processor to estimate stiffnesses and a virtual target using a policy model from an image, a proprioception, and a force about a task by a robot, the stiffnesses associated with a spatial point. The instructions also include instructions to compute a stiffness matrix for compliance parameters by a compliance component from a pose, the stiffnesses, and the virtual target. The instructions also include instructions to control the robot during the task using a compliance controller parameterized by the virtual target and the stiffness matrix.

In one embodiment, a non-transitory computer-readable medium that controls a robot during a task while satisfying compliance parameters through estimating stiffnesses and a virtual target associated with a motion and including instructions that when executed by a processor cause the processor to perform one or more functions is disclosed. The instructions include instructions to estimate stiffnesses and a virtual target using a policy model from an image, a proprioception, and a force about a task by a robot, the stiffnesses associated with a spatial point. The instructions also include instructions to compute a stiffness matrix for compliance parameters by a compliance component from a pose, the stiffnesses, and the virtual target. The instructions also include instructions to control the robot during the task using a compliance controller parameterized by the virtual target and the stiffness matrix.

In one embodiment, a method for controlling a robot during a task while satisfying compliance parameters by estimating stiffnesses and a virtual target associated with a motion is disclosed. In one embodiment, the method includes estimating stiffnesses and a virtual target using a policy model from an image, a proprioception, and a force about a task by a robot, the stiffnesses associated with a spatial point. The method also includes computing a stiffness matrix for compliance parameters by a compliance component from a pose, the stiffnesses, and the virtual target. The method also includes controlling the robot during the task using a compliance controller parameterized by the virtual target and the stiffness matrix.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an estimation system that predicts stiffnesses and a virtual target using a policy model for controlling a robot during a task and satisfying compliance parameters.

FIGS. 2A and 2B illustrate embodiments of the estimation system that is associated with predicting the stiffnesses and the virtual target and computing a stiffness matrix for the robot.

FIG. 3 illustrates one embodiment of the estimation system training the policy model to predict the stiffnesses using a diffusion policy.

FIGS. 4A and 4B illustrate examples of the robot executing a task using the policy model and the stiffnesses along the virtual target.

FIG. 5 illustrates one embodiment of a method that is associated with estimating the stiffnesses and the virtual target about the task by the robot using the policy model from an image, proprioception data, and force data; and

FIG. 6 illustrates one embodiment of a method that is associated with training the policy model to estimate the stiffnesses by removing noise associated with a demonstrated task through a diffusion policy.

### DETAILED DESCRIPTION

Systems, methods, and other embodiments associated with improving robotic compliance by estimating stiffnesses and a virtual target about a motion using a policy model during a task and satisfying compliance parameters are disclosed herein. In various implementations, systems controlling a robot have limited compliance before contact to prioritize precise position tracking while becoming compliant upon contact. Compliance can describe how force and motion variations in different directions are related. The policy model learning compliance directly using a demonstrated trajectory can lack critical information, thereby demanding detailed known dynamic parameters, multiple demonstrations on the exact task, etc. Correspondingly, the policy model is unable to handle new scene configurations and unexpected perturbations. For example, spatial variance during a task effects control during pivoting and pushing. Furthermore, task variance effects temporal and spatial properties of the compliance that change for satisfying three-dimensional (3D) motion and force demands. As such, compliant policies can rely upon pre-selected compliance parameters for a task or assume uniform stiffness (e.g., scalar value) in multiple directions when controlling the robot.

Moreover, the policy model learning robotic compliance from reinforcement learning (RL) through exploring force-motion variations can demand retraining for scene variations. Also, systems using fixed-parameter and low-level compliance controllers (e.g., impedance controller, an admittance controller, robotic joint controller, etc.) can lack disturbance robustness. The policy model learning compliance from human stiffness during a manipulation task can involve multiple repetitions of the same motion and encounter challenges for a visuomotor policy learning from different demonstrations. This approach can demand knowledge of human mass and damping that is difficult to acquire. In yet another approach, a policy model learns visuomotor policies with force feedback through encoding a force input using a data-driven network. Still, these systems predicting robotic position with uniform constant compliance have difficulties capturing the spatial and temporal variations of compliance parameters during a delicate manipulation task, thereby impacting system precision.

Therefore, in one embodiment, an estimation implements a policy model that dynamically adjusts system compliance behavior both spatially and temporally for a manipulation task by a robot from training with sparse demonstration data. For example, the robot varies multiple stiffnesses in direction and time during a task associated with a virtual target. In one approach, the policy model represents a compliance profile with additional stiffness values and a virtual target (e.g., a pose, a position, an orientation, etc.) associated with a robotically controlled component (e.g., a robotic limb) in real-world metric scales and coordinates. Here, the estimation system computes the virtual target in addition to a reference pose (e.g., robot end-effector pose) originally predicted by the policy model. Encoding a directional difference between the virtual target (e.g., desired path, trajectory, etc.) and the reference pose produces a spatial distribution of stiffnesses. In this way, a regular controller (e.g., a high-rate compliance controller) can utilize the predicted reference pose and the stiffnesses for achieving robust and adaptive compliance behaviors despite external uncertainties and disturbances.

In various implementations, the estimation system trains the policy model with few demonstrated tasks to derive a simple rule for a compliance profile that avoids excessive internal forces and encourages precise tracking. For example, the policy model learns to make subtle assumptions about a task by a robot rather than exact motions. This can involve computing a virtual target (e.g., a trajectory) and a related stiffness label by the policy model using encoded perception, encoded force visualization, and noise from a demonstrated task. The estimation system removes noise from a random vector that can identify a stiffnesses vector associated with the demonstrated task and encoded information in a diffusion policy. For instance, the policy trains using kinesthetic learning that allows demonstrations with varying compliance profiles to summarize a compliance profile for a task and quickly adjust compliance using visual and force feedback. In this way, the policy model approximates varying stiffnesses during a demonstrated task for different object variations and scene configurations during implementation, thereby increasing task precision and accuracy by a robot.

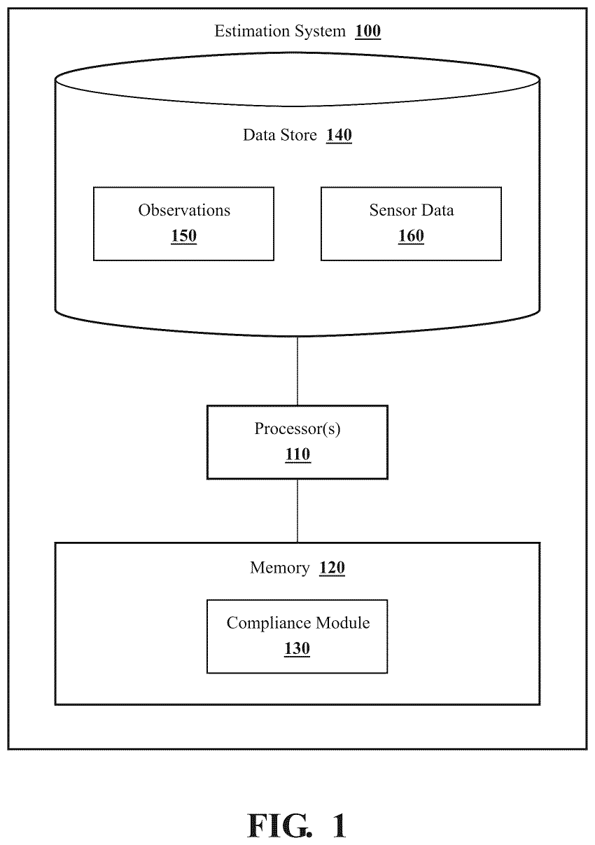

With reference to FIG. 1, one embodiment of an estimation system 100 that predicts stiffnesses and a virtual target using a policy model for controlling a robot during a task and satisfying compliance parameters is illustrated. In one embodiment, the estimation system 100 includes a memory 120 that stores a compliance module 130. The memory 120 is a random-access memory (RAM), a read-only memory (ROM), a hard-disk drive, a flash memory, or other suitable memory for storing the compliance module 130. The compliance module 130 is, for example, computer-readable instructions that when executed by the processor(s) 110 cause the processor(s) 110 to perform the various functions disclosed herein.

Moreover, the estimation system 100 and the compliance module 130 generally include instructions that function to control the processor(s) 110 to receive data inputs from one or more sensors of a robot. The inputs are, in one embodiment, observations of one or more objects in an environment proximate to a robot and/or other aspects about the surroundings. As provided for herein, the estimation system 100 and the compliance module 130, in one embodiment, acquire the sensor data 160 that includes at least camera images, motion data, force data, haptic data, proprioception data, etc., associated with a robot, a robotic task, etc.

In one embodiment, the estimation system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the compliance module 130 in executing various functions. In one embodiment, the data store 140 includes the sensor data 160 along with, for example, metadata that characterize various aspects of the sensor data 160. For example, the metadata can include location coordinates (e.g., longitude and latitude), relative map coordinates or tile identifiers, time/date stamps from when the separate sensor data 160 was generated, and so on. As further explained below, in one embodiment, the data store 140 further includes the observations 150 that can include data about a pose (e.g., spatiotemporal position), stiffnesses, and a virtual target predicted and outputted by a policy model associated with a task.

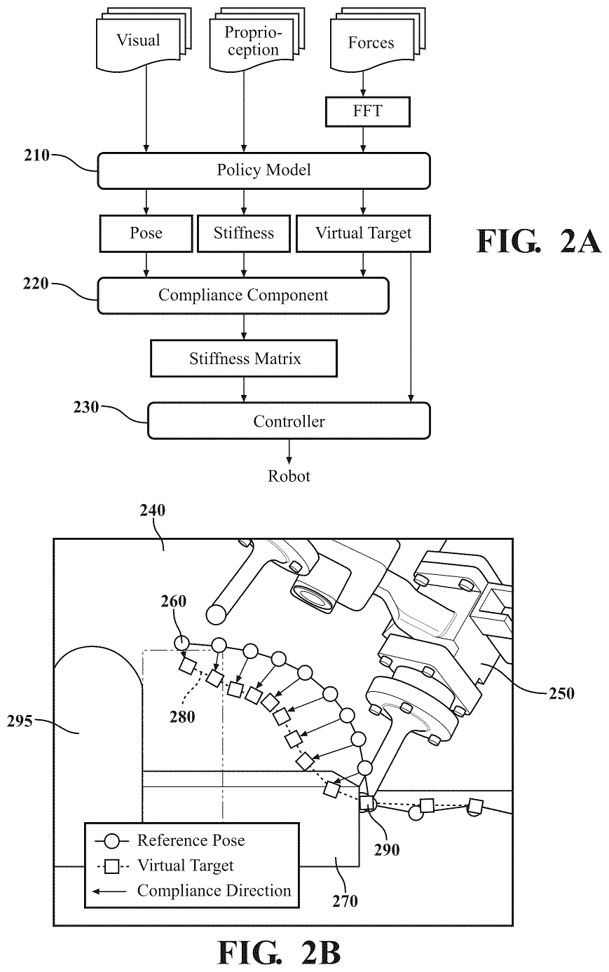

Now turning to FIGS. 2A and 2B, one embodiment of the estimation system 100 that is associated with predicting the stiffnesses and the virtual target and computing a stiffness matrix for a robot is illustrated. The estimation system 100 and the compliance module 130, in one embodiment, are further configured to perform additional tasks beyond controlling the respective sensors to acquire and provide the observations 150 and sensor data 160. For example, the estimation system 100 includes instructions that causes the processor 110 to estimate stiffnesses and a virtual target using a policy model 210 from an image, proprioception information, and force data about a task by a robot. Here, the stiffnesses can be associated with a spatial point. Furthermore, the compliance module 130 can compute a stiffness matrix for compliance parameters from a pose, the stiffnesses, and the virtual target. For instance, the compliance parameters define target properties for a path, a trajectory, a direction, etc., for a robot limb associated with completing the task. In one approach, the estimation system 100 can control the robot during the task using the compliance controller parameterized by the virtual target and the stiffness matrix.

In another example, the estimation system 100 derives a visual-force representation by encoding a perception and a force visualization using a transformer from a demonstrated task for the robot. Furthermore, the estimation system 100 computes a training target and a stiffness label by the policy model 210 using the perception that is encoded, the force visualization that is encoded, and noise from the demonstrated task. In one approach, the estimation system 100 trains the policy model 210 to estimate the pose, the stiffnesses, and the virtual target by iteratively removing the noise from a random vector in a diffusion policy.

Regarding further details about the robotic policies and compliance, a policy can be a function that maps feedback information about robotic motion as inputs (e.g., images, streamed video, force readings at contact, robot spatiotemporal position, joint angle, etc.) to action. Force readings can include contact force, torque data, pressure data, etc. A policy function can compute a reference position and policy correspondence (e.g., soft, rigid, etc.) about the action during a robotic task. The action can be related to assembling a vehicle while having precise control over compliance. For example, compliance associated with inserting rubber caps in a chassis differs from tracing and gluing weather strips along a vehicle hood. The estimation system 100 executes the robotic task while reducing errors and defects through avoiding excessive stiffness using adaptive policies at a spatial point (e.g., a contact point). This allows a robot workability with diverse items and provides robustness against outside disturbances when implementing a policy.

In FIG. 2A, the policy model 210 (e.g., a data-driven model, a neural network, etc.) during inference can estimate stiffnesses and a virtual target from an image about a scene, proprioception data, and force data involving a task by a robot. Force data can include contact force readings, torque data, pressure data, etc. As further explained below, the policy model 210 can be trained to predict noise associated with the task using a denoising function through diffusion. Furthermore, the policy model 210 can also compute and output a pose about a spatiotemporal position associated with a robotic component and complete the task. The compliance component 220 can compute and recover a stiffness matrix (e.g., 3×3) that is compliant with a path, trajectory, etc., associated with the task. For instance, the path includes stiffness in one or more directions (e.g., X, Y, Z) associated with a virtual target using a fixed equation having eigenvalues. A controller 230 (e.g., a compliance controller) can execute actions associated with the task using a model from the stiffness matrix and the virtual target while updating trajectory tracking at an elevated rate (e.g., 100 Hz) until the policy model 210 outputs new predictions for compliance, a policy, etc., parameters.

The output of the policy model 210 can vary. For example, the policy model 210 outputs a reference pose about a robot that is a vector including a rotation matrix. The virtual target can be a pose about the robot representing an actual target for tracking by a low-level compliance controller (e.g., a contact controller, a joint controller, etc.). The output can include a scalar value representing a stiffness magnitude in a low-stiffness direction. Furthermore, the estimation system 100 computes the virtual target such that the robot will exert the reference force if the reference pose is reached while tracking the virtual target with a stiffness. In one approach, the virtual target represents a position target into a force target. This allows having a uniform target representation using the estimation system 100 across different robot types. For instance, an impedance-controlled robot without a force sensor can also physically track and execute the virtual target similar to a low-level compliance controller.

Turning to FIG. 2B, a task 240 illustrates a robot 250 tracking parameters associated with compliance path 260 when lifting an object 270. Here, the compliance path 260 can include a compliance direction and a reference pose associated with a contact point (e.g., a pivot point) of the robot 250 with the object 270. The compliance direction can be associated with a stiffness value between the contact point and the object 270 along the compliance path 260. In one approach, the estimation system 100 allows control of the robot 250 to vary spatially for maintaining compliance in the pushing directions while having high stiffness in other directions along the arc motion of the compliance path 260 and a virtual target 280. In particular, the virtual target 280 can represent a position and an orientation of a spatial point 290 within an actual metric scale. When deviating from the compliance path 260, the virtual target can also indicate optimal force applied from the robot 250 that will manipulate the object 270. The stiffnesses can be represented by a directional difference between the virtual target 280 and the reference pose.

FIG. 2B, in one embodiment, includes the compliance module 130 adjusting dynamic compliance parameters for a spatial property and a temporal property associated with the task and a contact mode towards the object 270. The estimation system 100 controls an actuator of the robot 250 using the compliance parameters and the reference pose associated with an end-effector of the robot 250 that is predicted by the policy model 210. In one approach, the estimation system 100 computes the stiffness matrix using Equation (6) below by replacing a force direction with the direction from the reference pose included within the compliance path 260 towards the virtual target 280, thereby improving smoothness and adaptability.

The controller 230 can flip the object 270 using the stiffness matrix and the virtual target 280 by pivoting against a fixture area 295 (i.e., a corner, a wall, etc.). This task involves the robot 250:1) consistently maintaining contact force during the flipping motion regardless of an object shape, an object weight, and fixture locations; and 2) preventing sliding to a floor from an excessive contact force that makes maintaining good contact difficult. The estimation system 100 achieves these goals through estimating the stiffness matrix using the policy model 210 and tracking the virtual target 280 with the compliance path 260, thereby improving reliability during the flip.

Modeling robot compliance for the task 240 can involve expanding an action space of the robot 250. Consider a N dimensional system described by position x∈ [symbol] and force f∈ [symbol] . Compliance can be the elastic behavior between force and motion modeled by a spring-mass-damper system:

$$f = M \ddot{x} + K ( x - {x}_{r e f} ) + {K}_{D} \dot{x} . \qquad Equation ( 1 )$$

The three terms on the right-hand side represent inertia force, spring force, and damping force, respectively. x_{ref} is a reference position, at which the spring force is zero. The compliant behavior is described by the inertia matrix M∈R^{N×N}, stiffness matrix K∈R^{N×N} and damping matrix K_{D}∈R^{N×N}. Here, K_{D} can be user-specified if the compliance 1 is implemented by control. In other words, they can be added to the action space of a high-level policy while a low-level compliance controller (e.g., a joint controller, a contact controller, etc.) of the robot 250 implements the “virtual” stiffness, damping, inertia, etc., actions. In this way, the estimation system 100 maintains compliance during the task 240 when speed and dynamism of the high-level policy is insufficient at exhibiting compliance.

In one implementation, the controller 230 implements admittance control by processing force feedback inputs and outputting position targets. The robot 250 using a force control interface can also utilize impedance control, hybrid force-motion control, etc., during the task 240. In one approach, the task 240 involves manipulation modeling by the estimation system 100 where the robot 250 is a black box. This can involve assuming that a contact force dominates over others such as inertia force, friction, gravity, etc. These forces may be negligible compared with the contact force. The estimation system 100 ensures this assumption by avoiding rapid robot motion and using lightweight objects. Consider the robot 250 having N degrees of freedom, making n contacts with the environment. Denote λ∈ [symbol] as the vector of contact normal forces, Newton's Second Law can be written as following with the contact force assumption:

$${J}^{T} λ = f . \qquad Equation ( 2 )$$

where J is the Contact Jacobian matrix that maps contact force into a generalized force space for the robot 250. Denote v∈ [symbol] as the generalized velocity vector, the Jacobian J can also describe the velocity constraint imposed by contacts:

$$J v \geq 0 . \qquad Equation ( 3 )$$

Accordingly, the estimation system 100 derives v to execute a smooth and precise path for the task 240 along the compliance path 260.

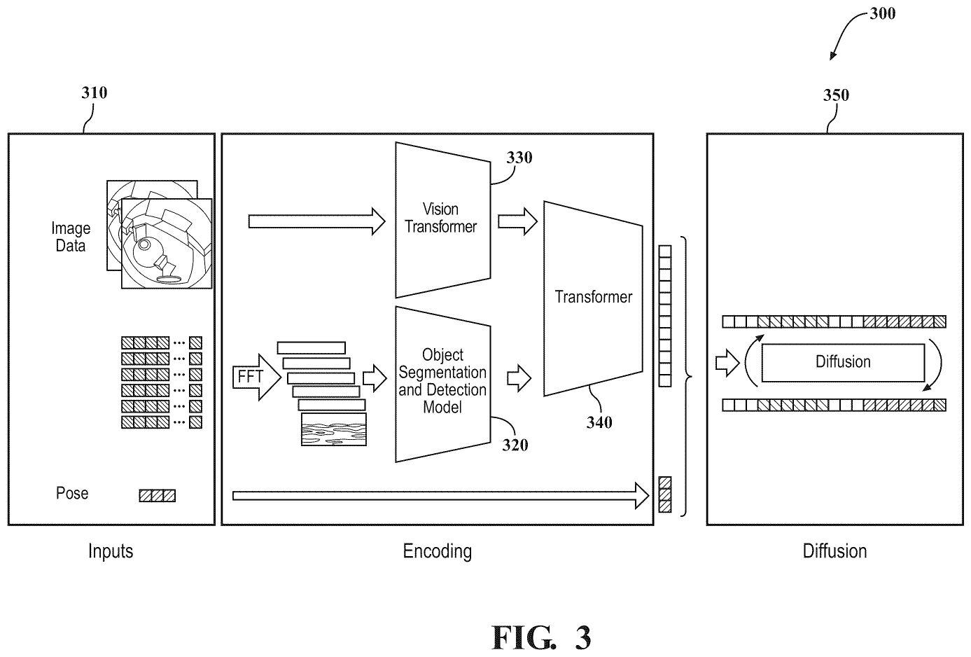

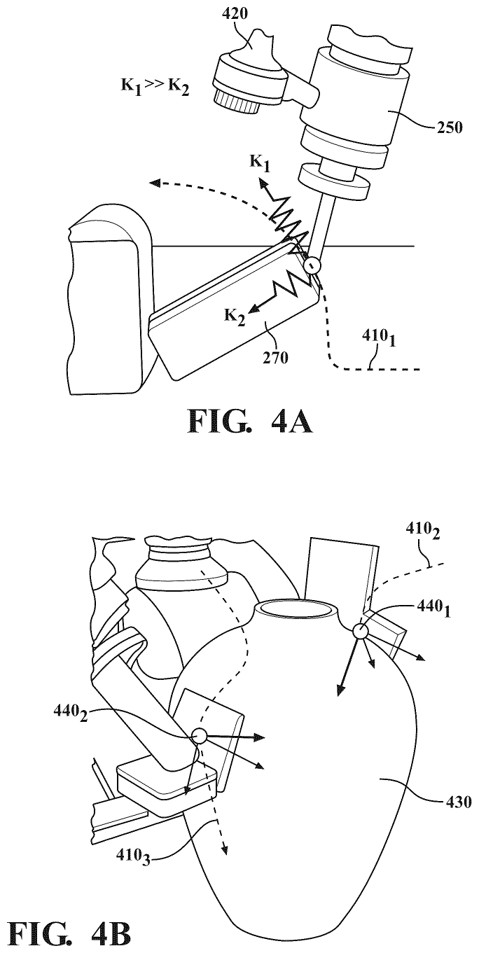

Concerning FIG. 3, one embodiment of the estimation system 100 training the policy model 210 to predict the stiffnesses using a diffusion policy is illustrated. Here, the estimation system 100 can utilize kinesthetic learning rather than teleoperation about a demonstrated task using the pipeline 300. For instance, the demonstrated task entails a few demonstrated actions, a single demonstrated task, etc., thereby reducing training time. As illustrated in FIGS. 4A and 4B, this allows an operator (e.g., a human, an animal, a robot, etc.) to readily demonstrate variable compliance behavior under direct haptic feedback. A setup can include a limb (e.g., an arm) of the robot 250 having a robot manipulator that provides position feedback, a camera 420 (e.g., a red-green-blue (RGB) camera, a fisheye camera, etc.) that records visual and environment information, and a force torque sensor mounted near the limb that acquired force data with the object 270. As previously explained, force data can include contact force readings, torque data, pressure data, etc.

A demonstrated task can involve limited stiffness, limited damping, and limited mass for the controller 230 so that the operator can move the robot 250 freely. Low damping and mass are achievable during a demonstrated task with a human hand providing a natural external stabilization. Furthermore, training can involve increasing robot damping and a virtual mass to maintain the stability of the admittance controller.

The estimation system 100 predicting compliance from the demonstrated task can involve factoring varying stiffnesses during manipulation. High stiffness provides position accuracy under force disturbances. Low stiffness can be demanded when high stiffness controls impose velocity constraints that conflict with the contact constraints from Equation (3) and generate very elevated internal force. In one approach, the estimation system 100 learns from a single demonstrated task exhibiting limited variations demanded during training with kinesthetic teaching. For example, the estimation system 100 involves the operator changing the effective damping and mass of a robotic hand that exhibits the demonstrated task having constant force and position for a time period. Here, the estimation system 100 can utilize pre-selected values for mass and damping and compute a stiffness matrix rather than estimating operator stiffness. This avoids very elevated internal forces in manipulation and accurate tracking during a target motion, thereby improving performance of the policy model.

A stiffness direction in a generalized space for the stiffnesses outputted by the policy model 210 can be represented as follows. The estimation system 100 can represent a low stiffness k_{low} in the direction of the force feedback and a high stiffness k_{high} in all other directions. This follows from mechanics that rows of a Contact Jacobian J can represent the directions of contact normal forces. This can form a polyhedral convex cone in the generalized force space. Assumptions involving stiffness direction can include non-zero contact force and limited pinching contacts. Non-zero contact force can be that contact between the robot 250 and the object 270 have non-zero contact forces. In another example, limited pinching contacts include a cone formed by rows of the Contact Jacobian J that are contained in a dual cone.

Moreover, non-zero contact points can be satisfied by making contacts clearly during a demonstration task. Limited pinching contacts can mean that contacts on the robot 250 avoid being overly restrictive. The estimation system 100 training the policy model 210 with these assumptions can stipulate that the robot 250 under external contact described by Equation (2) has a solution v that satisfies a contact constraint when foregoing velocity control in the direction of feedback force f in the generalized space.

Foregoing velocity control in a force direction can mean that the velocity has a free component:

$$v = {v}_{0} + k f = {v}_{0} + k {J}^{T} λ . \qquad Equation ( 4 )$$

where k is an arbitrary scaling factor, v₀ denotes the components of generalized velocity in other directions. When having non-zero contact, the contact force λ should have positive components, J^{T}λ represents a ray inside the cone formed by rows of J. Lacking pinching contacts means that a cone is contained in a dual cone {x∈ [symbol] |Jx≥0} such that:

$$J {J}^{T} λ > 0 . \qquad Equation ( 5 )$$

Then JV=JV₀+kJJ^{T}λ>0 for sizeable k values.

The estimation system 100 exhibiting one-dimensional and low stiffness control can avoid a constraint violation. As such, elevated stiffness in other directions can improve position tracking. Let K₀∈R [symbol] be a diagonal matrix with [k_{low}, k_{high}, . . . , k_{high}] on a diagonal, and S∈ [symbol] be a matrix whose columns form an orthonormal basis of [symbol] with a first column as f/|f|. The stiffness matrix can be written as:

$$K = S {K}_{0} {S}^{- 1} . \qquad Equation ( 6 )$$

We use k_{high} in all directions when |f| is small.

An elevated stiffness k_{high} can support accurate position tracking in multiple directions and can be set empirically. In one approach, a low stiffness value is zero. However, since the low stiffness direction is estimated from noisy force signal, stiffness can decrease continuously with the force magnitude:

$${k}_{low} = \{ \begin{matrix}{k}_{max} , & \vert f \vert < {f}_{min} \\ {k}_{max} - ( {k}_{max} - {k}_{min} ) \frac{\vert f \vert - {f}_{min}}{{f}_{max} - {f}_{min}} , & {f}_{min} \leq \vert f \vert \leq {f}_{max} \\ {k}_{min} , & \vert f \vert > {f}_{max}\end{matrix} . \qquad Equation ( 7 )$$

where kₘₐₓ, kₘᵢₙ, fₘₐₓ, and fₘᵢₙ are parameters determined by the estimation system 100.

Still referring to FIG. 3, learning the policy model 210 can include using a diffusion policy that injects noise after encoding the inputs 310 and denoising outputs from transformer 340. Here, the estimation system 100 derives a visual-force representation by encoding a perception and a force visualization using a transformer from a demonstrated task for the robot. The transformer identifies relationships between sources and inputs. An output of the transformer is an encoding having visual and force information about a demonstrated task. As previously explained, the estimation system 100 can compute a training target and a stiffness label by the policy model 210 using the perception that is encoded, the force visualization that is encoded, and noise from the demonstrated task. In one approach, the estimation system 100 trains the policy model 210 to estimate the pose, the stiffnesses, and the virtual target by iteratively removing the noise from a random vector until finding a vector of stiffnesses in a diffusion policy.

In another example, the estimation system 100 can encode a perception of an environment using a vision transformer 330 from image data, visual data, etc., associated with a demonstrated task. The environment can include both static and dynamic objects. Encoding allows for identifying salient features within the environment. As explained in detail below, the estimation system 100 can encode the force visualization using a fast fourier transform (FFT) and object segmentation and detection model 320 (e.g., a convolutional network) using force data, pressure data, etc., associated with the demonstrated task. A transformer 340 can be a trained network (e.g., a convolutional network) that predicts a visual-force representation from encoded information using a self-attention network and a cross-attention network. A self-attention network can identify relationships between different positions within a given input sequence, tokenized information, a token series, etc. A cross-attention network can compute and identify relationships between different data sequences, tokenized information, a token series, etc. As such, the transformer 340 can identify salient relationships between an encoded perception of a surrounding environment and encoded force data.

Outputs of the transformer 340 can be computed spatial-varying, temporal-varying, etc., compliance labels of features from a demonstrated task that allows the pipeline in FIG. 2A and the policy model 210 to be scalable upon training. This allows the policy model 210 to learn adaptive visual-force representations about a task by a robot for execution within a surrounding environment. The estimation system 100 concatenates the visual-force representation with the pose such as a robot end-effector. This information is fed to the diffusion policy 350 as a condition for iteratively denoising a random vector into a vector of the stiffnesses, and the virtual target.

The diffusion policy 350 can include a reference action and a target stiffness associated with a demonstrated task and trains the policy model 210 using visual data, force data, and proprioception data (e.g., pose). The inputs 310 can include image data (e.g., RGB data) of a scene captured by a robot, force data (e.g., force, torque, etc.) about a demonstrated task, and a pose about the robot. In another approach, encoding the force data can include temporal encoding with causal convolution (e.g., 5-layer causal convolution network) that captures causal relations between events from sequential data like force. Encoding the force data can also include a FFT that converts a dimension of a reading into a two-dimensional (2D) spectrogram. In other words, the spectrogram can represent a frequency response of the force data.

In various implementations, the estimation system 100 also feeds a spectrogram mapping frequency against time to a visual recognition model. For instance, the estimation system 100 includes an object segmentation and detection model 320 (e.g., a resnet) with a modified input channel (e.g., six channels for each wrench dimension), thereby simplifying processing. In one approach, the object segmentation and detection model 320 has a coordinate convolution layer at initial layers for reducing translational invariances from the spectrogram. The image data from the past timesteps (e.g., past two timesteps) are resized with random cropping then encoded using a vision transformer 330 (e.g., contrastive language-image pre-training (CLIP) visual transformer model).

An encoder layer of the transformer 340 receives the encoded image and extracted force data upon encoding. As previously explained, the transformer 340 can predict and output a visual-force representation to the diffusion policy 350 using a self-attention network and a cross-attention network that allow the policy model 210 to learn adaptive visual-force representations. In one approach, the diffusion policy 350 is a convolutional-based, a transformer-based, etc., UNet that adds a certain noise level iteratively to the visual-force representation. The diffusion policy 350 can train the policy model 210 to predict noise by minimizing losses between predicted noise and actual noise using a denoising function.

In various implementations, the pipeline 300 has the diffusion policy running in a receding-horizon manner such that an action trajectory by the robot 250 is predicted using recent observations: 1) image data, 2) robot end-effector poses, and 3) force data. Here, the action trajectory demonstrated by an operator has natural noise (e.g., white noise) that the diffusion policy 350 iteratively denoises until minimizing losses with training data. Iterations can include collecting force feedback during the demonstrated task and outputting haptic feedback associated with the force feedback and variable compliance.

In another approach, the pipeline 300 trains the policy model 210 to pass an episode of wrench data through a moving average filter having an X window size. Wrench data can be a combined representation of forces and torques (e.g., moments) exerted by an end effector of the robot 250. A stiffness is computed using Equation (6) and the estimation system 100 computes a virtual target following a 3D mechanical spring. The filtering wrench data can smoothen the virtual target and supply action labels with hindsight information about forthcoming contacts. This results in smooth contact when engaging motions by the robot 250.

Now discussing FIGS. 4A and 4B, examples of the robot 250 executing a task using the policy model 210 and the stiffnesses along the virtual target are illustrated. In FIG. 4A, the task is the robot 250 lifting the object 270 pinned against a wall with a contact point(s). The estimation system 100, the policy model 210, and the compliance component 220 predict multiple stiffness magnitude and direction for outputs K. For instance, an outputted policy is having an elevated stiffness magnitude in a direction of motion K₁. The policy also computes a stiffness magnitude K₂ in a perpendicular direction to the contact point(s) that allows the robot 250 steady control with the object 270. For example, the robot 250 sets K₁>>K₂ along the trajectory 4101 that is tracked and adapted by the estimation system 100 using the camera 420. In this way, the robot 250 avoids excessive force that could damage the object 270 while executing the trajectory 4101 with multiple stiffnesses K₁ and K₂, thereby improving system reliability with handling delicate objects.

FIG. 4B illustrates the robot 250 controlling movement of a vase 430 along multiple trajectories 4102 and 4103 and multiple stiffnesses 4401 and 4402 using the estimation system 100. Stiffnesses 4401 and 4402 varying in magnitude and X-Y-Z directions allow the robot 250 to gently and finely control the vase 430 during complex movements. For instance, the robot 250 lifts the vase 430 without excessive force in any direction through the multiple stiffnesses 4401 and 4402. This allows gentle and nuanced control by the robot 250 using the policy model 210 while meeting policy parameters. The policy model 210 can do so while being trained with a single, limited, few, etc., demonstrations of a task by an operator, thereby reducing training complexity and time.

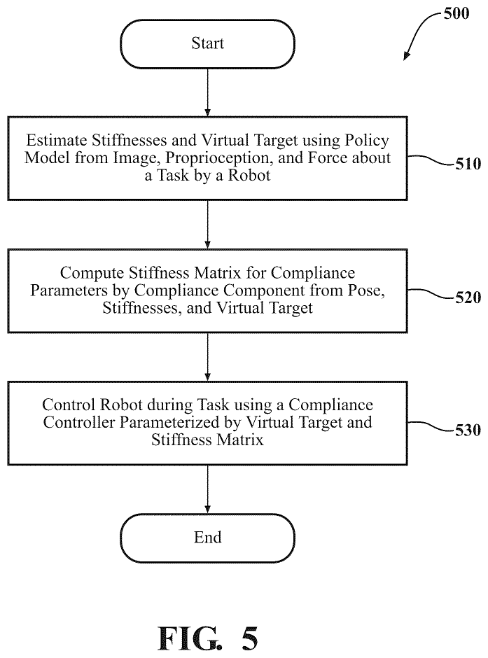

FIG. 5 illustrates one embodiment of a method 500 that is associated with estimating the stiffnesses and a virtual target involving execution of a task by a robot using a policy model from an image, proprioception data, and force data. The method 500 will be discussed from the perspective of the estimation system 100 of FIG. 1. While the method 500 is discussed in combination with the estimation system 100, it should be appreciated that the method 500 is not limited to being implemented within the estimation system 100 but is instead one example of a system that may implement the method 500.

At 510, the estimation system 100 estimates stiffnesses and a virtual target using a policy model from image, proprioception, and force data about a task (e.g., lifting, moving, etc.) by a robot. In one approach, a stiffness can be magnitude and direction of a contact point, a spatial point, etc., associated with the robot executing a task along a trajectory. In another approach, the virtual target is a pose about the robot representing an actual target for tracking by a compliance controller (e.g., a low-level compliance controller, a joint controller, etc.). The virtual target can represent a position target into a force target. As previously explained, the estimation system 100 can compute the virtual target such that the robot will exert the reference force if the reference pose is reached while tracking the virtual target with a stiffness. The virtual target can also be associated with an actual metric scale and indicate optimal applied force from the robot that will manipulate an object when deviating from motion path.

Moreover, the policy model may be a data-driven model that outputs a reference pose in vector form about a robot derived from the sensor data 160. Furthermore, the stiffnesses can be associated with multiple action modes such as one or more contact points, spatial points, etc., for executing the task by the robot. In this way, the policy model can complete complex tasks by varying stiffness magnitude and direction that allows smooth and fine control by the robot 250.

At 520, the compliance module 130 computes a stiffness matrix for compliance parameters from the pose, the stiffnesses, and the virtual target. In one example, the compliance parameters define properties for a path, a trajectory, a direction, etc., for a robot limb associated with completing the task. The compliance module 130 can compute and recover the stiffness matrix (e.g., 3×3) that satisfies physical, spatial, temporal, etc., properties of a path, trajectory, etc., associated with the task. As previously explained, in an implementation, the compliance module 130 computes the stiffness matrix by replacing a force direction with the direction from the reference pose included within a compliance path towards the virtual target.

At 530, a compliance controller parameterized by the virtual target and the stiffness matrix controls the robot during the task. For example, the compliance controller is a low-level controller (e.g., a joint controller, a contact controller, etc.) that executes actions associated with the task using a model from the stiffness matrix and the virtual target. Here, the estimation system 100 can update trajectory tracking at an elevated rate (e.g., 100 Hz) until the policy model outputs new predictions for stiffnesses and the virtual target that satisfies a target policy (e.g., low contact jitter). Accordingly, the estimation system 100 improves movement accuracy and precision using the policy model through predicting multiple stiffness values and factoring a virtual target for the task by the robot.

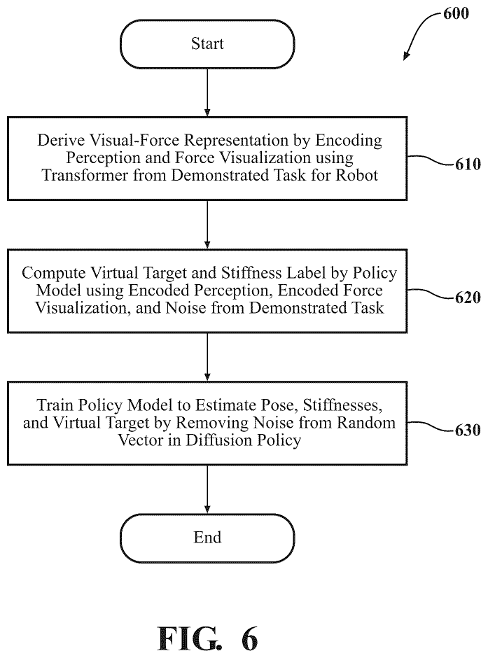

Regarding FIG. 6, one embodiment of a method 600 that is associated with training a policy model to estimate stiffnesses by removing noise associated with a demonstrated task through a diffusion policy is illustrated. Certain aspects of the method 600 will be discussed from the perspective of the estimation system 100 of FIG. 1. While the method 600 is discussed in combination with the estimation system 100, it should be appreciated that the method 600 is not limited to being implemented within the estimation system 100 but is instead one example of a system that may implement the method 600.

At 610, the estimation system 100 derives a visual-force representation by encoding perception and encoding force visualization using a transformer from a demonstrated task for the robot. As previously explained, the estimation system 100 through a training pipeline may encode a perception of an environment using a vision transformer from image data, visual data, etc., associated with the demonstrated task. The demonstrated task may be performed one or more times by an operator and include one or more actions that manipulate an object. Furthermore, the estimation system 100 can encode the force visualization using a FFT and an object segmentation and detection model (e.g., a convolutional network) using force data, pressure data, etc., associated with the demonstrated task. In one approach, the transformer predicts a visual-force representation using a self-attention network and a cross-attention network that efficiently identify unique relationships within segments of a data stream. Outputs of the transformer can be computed spatial-varying, temporal-varying, etc., compliance labels from a demonstrated task that allows the policy model to be scalable upon training and learn adaptive visual-force representations.

At 620, the estimation system 100 computes a virtual target and a stiffness label using a policy model with the encoded perception, the encoded force visualization, and noise associated with the demonstrated task. For example, the transformer outputs spatial-varying, temporal-varying, etc., compliance labels of features from a demonstrated task. Furthermore, the virtual target can be a pose about the robot representing an actual target for tracking by a compliance controller (e.g., a low-level compliance controller, a joint controller, etc.).

At 630, the estimation system 100 trains the policy model to estimate pose, stiffnesses, and a virtual target for a task by removing noise from a random vector in a diffusion policy. Here, the estimation system 100 can concatenate the visual-force representation with a pose about a robotic limb during the task. As previously explained, the diffusion policy can include a reference action and a target stiffness associated with the demonstrated task for training the policy model. In another example, the diffusion policy 350 is a convolutional-based, a transformer-based, etc., UNet that adds a certain noise level iteratively to the visual-force representation. Furthermore, the diffusion policy can train the policy model to predict noise by minimizing losses between predicted noise and actual noise using a denoising function. Accordingly, the policy model learns to approximate varying stiffnesses during the demonstrated task for different object variations and scene configurations during implementation, thereby increasing system performance and precision for robotically executed tasks.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
estimate stiffnesses and a virtual target using a policy model from an image, a proprioception, and a force about a task by a robot, the stiffnesses associated with a spatial point;
compute a stiffness matrix for compliance parameters by a compliance component from a pose, the stiffnesses, and the virtual target; and
control the robot during the task using a compliance controller parameterized by the virtual target and the stiffness matrix.

2. The estimation system of claim 1 further includes instructions to:
derive a visual-force representation by encoding a perception and a force visualization using a transformer from a demonstrated task for the robot;
compute a training target and a stiffness label by the policy model using the perception that is encoded, the force visualization that is encoded, and noise from the demonstrated task; and
train the policy model to estimate the pose, the stiffnesses, and the virtual target by iteratively removing the noise from a random vector in a diffusion policy.

3. The estimation system of claim 2 further includes instructions to:
predict the noise by the policy model for the task using a denoising function.

4. The estimation system of claim 2 further includes instructions to:
encode the perception using a vision transformer from visual data associated with the demonstrated task;
encode the force visualization using a fast fourier transform (FFT) and a convolutional network using pressure data associated with the demonstrated task;
predict by the transformer the visual-force representation using a self-attention network and a cross-attention network; and
concatenate and feed the visual-force representation with the pose to the diffusion policy.

5. The estimation system of claim 2 further includes instructions to:
collect force feedback during the demonstrated task; and
output haptic feedback associated with the force feedback and variable compliance.

6. The estimation system of claim 1 further includes instructions to:
adjust dynamically the compliance parameters for a spatial property and a temporal property associated with the task and a contact mode towards an object; and
control an actuator of the robot using the compliance parameters.

7. The estimation system of claim 1, wherein:
the virtual target represents a position and an orientation of the spatial point within an actual metric scale;
the pose is a reference pose associated with an end-effector of the robot that is predicted by the policy model; and
the stiffnesses represent a directional difference between the virtual target and the reference pose.

8. The estimation system of claim 1, wherein the compliance parameters are properties about a path and a direction for a robot limb associated with the task.

9. A non-transitory computer-readable medium comprising:
instructions that when executed by a processor cause the processor to:
estimate stiffnesses and a virtual target using a policy model from an image, a proprioception, and a force about a task by a robot, the stiffnesses associated with a spatial point;
compute a stiffness matrix for compliance parameters by a compliance component from a pose, the stiffnesses, and the virtual target; and
control the robot during the task using a compliance controller parameterized by the virtual target and the stiffness matrix.

10. The non-transitory computer-readable medium of claim 9 further includes instructions to:
derive a visual-force representation by encoding a perception and a force visualization using a transformer from a demonstrated task for the robot;
compute a training target and a stiffness label by the policy model using the perception that is encoded, the force visualization that is encoded, and noise from the demonstrated task; and
train the policy model to estimate the pose, the stiffnesses, and the virtual target by iteratively removing the noise from a random vector in a diffusion policy.

11. The non-transitory computer-readable medium of claim 10 further includes instructions to:
predict the noise by the policy model for the task using a denoising function.

12. The non-transitory computer-readable medium of claim 10 further includes instructions to:
encode the perception using a vision transformer from visual data associated with the demonstrated task;
encode the force visualization using a fast fourier transform (FFT) and a convolutional network using pressure data associated with the demonstrated task;
predict by the transformer the visual-force representation using a self-attention network and a cross-attention network; and
concatenate and feed the visual-force representation with the pose to the diffusion policy.

13. A method comprising:
estimating stiffnesses and a virtual target using a policy model from an image, a proprioception, and a force about a task by a robot, the stiffnesses associated with a spatial point;
computing a stiffness matrix for compliance parameters by a compliance component from a pose, the stiffnesses, and the virtual target; and
controlling the robot during the task using a compliance controller parameterized by the virtual target and the stiffness matrix.

14. The method of claim 13 further comprising:
deriving a visual-force representation by encoding a perception and a force visualization using a transformer from a demonstrated task for the robot;
computing a training target and a stiffness label by the policy model using the perception that is encoded, the force visualization that is encoded, and noise from the demonstrated task; and
training the policy model to estimate the pose, the stiffnesses, and the virtual target by iteratively removing the noise from a random vector in a diffusion policy.

15. The method of claim 14 further comprising:
predicting the noise by the policy model for the task using a denoising function.

16. The method of claim 14 further comprising:
encoding the perception using a vision transformer from visual data associated with the demonstrated task;
encoding the force visualization using a fast fourier transform (FFT) and a convolutional network using pressure data associated with the demonstrated task;
predicting by the transformer the visual-force representation using a self-attention network and a cross-attention network; and
concatenating and feeding the visual-force representation with the pose to the diffusion policy.

17. The method of claim 14 further comprising:
collecting force feedback during the demonstrated task; and
outputting haptic feedback associated with the force feedback and variable compliance.

18. The method of claim 13 further comprising:
adjusting dynamically the compliance parameters for a spatial property and a temporal property associated with the task and a contact mode towards an object; and
controlling an actuator of the robot using the compliance parameters.

19. The method of claim 13, wherein:
the virtual target represents a position and an orientation of the spatial point within an actual metric scale;
the pose is a reference pose associated with an end-effector of the robot that is predicted by the policy model; and
the stiffnesses represent a directional difference between the virtual target and the reference pose.

20. The method of claim 13, wherein the compliance parameters are properties about a path and a direction for a robot limb associated with the task.
